(19) United States
(12) Patent Application Publication
(10) Pub. No.: US 2026/0244884 A1
(43) Pub. Date: Aug. 20, 2026

(54) METHOD AND SYSTEM FOR PROVIDING REAL-TIME TARGETED PRODUCT FACING BASED ON ANALYSIS OF RADIO FREQUENCY IDENTIFICATION (RFID) TAG DATA

(71) Applicant: T-Mobile Innovations LLC, Overland Park, KS (US)

(72) Inventors: Lyle BERTZ, Lee’s Summit, MO (US); Robert BUTLER, Overland Park, KS (US); Zheng FANG, Mclean, VA (US); Ankit MUCHHALA, Leesburg, VA (US)

(21) Appl. No.: 19/055,490

(22) Filed: Feb. 17, 2025

(51) Int. Cl. G06K 7/10; G06Q 10/087

(52) U.S. Cl. CPC G06K 7/10366; G06Q 10/087

(57) ABSTRACT

A computer-implemented method of analyzing radio frequency identification (RFID) tag data read from tags on product items to provide targeted product facing is provided. The method comprises receiving tag data associated with tags read via one or more readers, wherein each of the tags is attached to a respective one of product items on a shelving unit, and wherein the tag data comprises tag identification information and receive signal information associated with respective ones of the tags; and product identification information associated with respective ones of the product items; analyzing the tag data to determine an entropy measure associated with a placement of the product items on the shelving unit; and initiating based on the entropy measure failing to satisfy one or more criteria, facing for one or more product items of the product items.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Radio frequency identification (RFID) systems generally include at least one reader that communicates with at least one RFID tag (which may generally be referred to as a tag) using radio frequency (RF) signals. Each tag may be associated with (e.g., attached to or embedded in) an entity (e.g., an item or an individual) and may store identification (ID) information about the respective entity. RFID systems may use active tags that include an internal power source, such as a battery, and/or passive tags that do not include an internal power source, but instead are remotely powered by the reader.

RFID systems may be used in a variety of applications. For example, RFID systems have been used in supply chain management applications to identify and track merchandise throughout manufacture, warehouse storage, transportation, distribution, and retail sales. RFID systems have also been used in inventory management to track and monitor the location and status of store items.

### SUMMARY

In an embodiment, a computer-implemented method of analyzing radio frequency identification (RFID) tag data read from RFID tags on product items to provide targeted product facing is provided. The method comprises receiving, by an application at a computer system, tag data associated with a plurality of tags read via one or more readers, wherein each of the plurality of tags is attached to a respective one of a plurality of product items on a shelving unit, and wherein the tag data comprises tag identification information and receive signal information associated with respective ones of the plurality of tags; and product identification information associated with respective ones of the plurality of product items; analyzing, by the application, the tag data to determine an entropy measure associated with a placement of the plurality of product items on the shelving unit; and initiating, by the application, based on the entropy measure failing to satisfy one or more criteria, facing for one or more product items of the plurality of product items.

In another embodiment, a computer-implemented method comprises receiving, by an application at a computer system, tag data associated with a plurality of tags read via one or more readers, wherein each of the plurality of tags is attached to a respective one of a plurality of product items on one or more shelving units; analyzing, by the application, the tag data to identify a first facing event associated with a first product item of the plurality of product items and a second facing event associated with a second product item of the plurality of product items; and prioritizing, by the application, initiation of the first facing event over the second facing event based on one or more criteria, wherein the prioritizing comprises initiating, by the application, facing for the first product item; and initiating, by the application, facing for the second product item after initiating the facing for the first product item.

In yet another embodiment, a method comprising receiving, by an application at a computer system, tag data associated with a plurality of tags read via one or more readers, wherein each of the plurality of tags is attached to a respective one of a plurality of product items of a particular product on a shelving unit; analyzing, by the application, the tag data to determine a quantity of the plurality of product items; predicting, by the application, a low-stock event associated with the particular product based on a comparison of the determined quantity of the plurality of product items of the particular product on the shelving unit to sales activity data associated with the particular product; and initiating, by the application, facing for the particular product based on the predicted low-stock event.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a facing system that utilizes radio frequency identification (RFID) technologies to provide real-time targeted facing according to an embodiment of the disclosure.

FIGS. 2A-2D are flow charts of a method according to an embodiment of the disclosure.

FIG. 3 is a flow chart of another method according to an embodiment of the disclosure.

FIG. 4 is a flow chart of yet another method according to an embodiment of the disclosure.

FIG. 5 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

In retail, facing is the process of making products presentable to customers. For instance, facing may include bringing products to the front of the shelf and making sure their labels are facing forwards. In some examples, facing may also include restocking (e.g., when the quantity of a certain product is below a desirable threshold). To determine where to place the products, a map called a planogram is used. A planogram provides a visual representation that maps out the exact placement of products on a shelf, detailing where each item is to be positioned. For instance, the planogram may provide a designated point on the front of the shelf where the pricing label of a product is to be within a certain distance (e.g., about +/- 2 feet) from this designated point. In other words, the planogram may indicate not only how products are to be positioned but also how products are to be oriented. The facing process can vary by store.

As used herein, the terms “placement of a product” may refer to the position and the orientation of the product, where the orientation may refer to the direction the product faces. As used herein, the terms “facing of a product” may refer to the front of the product, for example, where the price label is located. Generally, the facing of a product may refer to a desirable or presentable face (or side) of the product.

Initially, the person stocking the product items is responsible for using the planogram to place the products and getting the products properly faced. All subsequent facing activities are incurred by an in-store sales associate until there is a restock. Today, facing is typically performed every 3-4 hours by in-store sales associates. This can be time-consuming and costly. Further, as sale activities in a store can vary throughout the day, performing facing based on a fixed schedule may not meet the need of the store in real time. For instance, if a customer cannot find a certain product item in the store, the customer may go to another store. Thus, failing to meet the real-time needs of the store may further cause revenue loss and customer dissatisfaction. While radio frequency identification (RFID) technologies may be used in retail, this use is most focused on things such as inventory management. The present disclosure expands the use of RFID technologies to facing activities.

The present disclosure provides a technical solution to the aforementioned technical problems in the technical field of identifying placements (e.g., positions and facings) of products and/or items using RFID technologies to provide real-time targeted facing. More specifically, the present disclosure provides a system (e.g., in a retail or warehouse environment) that uses RFID tags to locate product items. For instance, a store may have various product items placed on shelving units, where tags (RFID tags) may be attached to respective ones of the product items. In an example, each tag may be attached to the front of a respective product item (e.g., where the price label is located). The system includes readers (RFID tag readers including fixed readers installed at fixed locations and/or portable readers that move within the store) to continuously scan the store and read the tags. The system further includes a computer system with a product facing application (e.g., software) executing on the computer system that continuously receives, from the readers, tag data read from the tags. The tag data may include various information, such as tag identification information identifying respective tags, product identification information identifying respective products, and receive signal information (e.g., receive signal strength indicator (RSSI) measurements) associated with the tags. In an example, each tag may store a tag identifier identifying the respective tag and a product code (e.g., a stock keeping unit (SKU) code and/or a universal product code (UPC)) identifying the corresponding product item where the tag is attached. The RSSI associated with each tag may be determined by a corresponding reader based on a signal reception from the respective tag.

The product facing application analyzes the tag data to determine locations of the tags and corresponding facings of the product items. If there isn’t confidence in the location measurements of the product items, the product facing application infers that facing needs to take place. The product facing application determines clusters of product items based on this tag data and applies an entropy algorithm to infer or determine a level of disorder or entropy. If the level of disorder or entropy is too high (e.g., exceeds a threshold or fails to satisfy certain criteria), the product facing application determines that facing should occur, and thus may initiate facing.

In an embodiment, the entropy algorithm may measure a deviation of placements of the product items from a corresponding planogram comprising product target facing information (e.g., designated points on shelving units for the product items). If the deviation exceeds a threshold, the product facing application determines that the entropy is too high and facing should occur. To that end, the product facing application may analyze the tag data against the planogram. As part of the analysis, the product facing application may determine location information associated with tags based on the receive signal information (e.g., RSSI measurements) in the tag data (e.g., using a triangulation technique). Because the tags are attached to the front of the respective product items, the location information is indicative of orientations (e.g., facings) of the respective product items. The product facing application may compare the location information to the product target facing information. In an example, the product facing application may determine, based on the comparison, that at least a first product item of the product items fails to satisfy a target facing associated with first product item. For instance, a distance between a facing of the first product item and a respective designated point (e.g., on a respective shelf) for the first product item exceeds a certain threshold (e.g., about +/-1, 2, or 3 feet). Accordingly, the product facing application may initiate facing for the first product item.

In another embodiment, the entropy algorithm may measure a scatterness (or randomness) of locations of a cluster of RFID tags (which correspondingly indicates a scatterness of the product items). If the cluster for the product items of a particular product becomes scattered or starts mixing with product items of another product, the product facing application determines that the entropy is too high and facing should occur. To that end, the product facing application may determine, based on the product identification information in the tag data, that the product items include first products items of a first product and second product items of a second product different than the first product. The product facing application may determine, based on the receive signal information in the tag data, location information for respective ones of the product items. In an example, the product facing application may determine, based on the location information, that the first product items are scattered within locations of the second product items. Accordingly, the product facing application may initiate facing for the first product items and/or the second product items.

In yet another embodiment, the entropy algorithm may measure a variation in RSSI measurements associated with a cluster of RFID tags (each attached to a corresponding product item). If the variation exceeds a threshold, the product facing application determines that the entropy is too high and facing should occur. To that end, the product facing application may determine, based on the product identification information in the tag data, that all of the plurality of product items are of the same particular product. The product facing application may determine, based on the receive signal information in the tag data, RSSIs of respective ones of the tags and associated product items. Because the product items of the same particular product may be placed next to each other on the shelf and each tag is on a respective product item, the RSSIs (associated with the tags) measured from a specific reader is expected to be close to each other (e.g., a variation of less than 1-2 decibels (dBs)). In an example, the product facing application may determine a variation of the RSSIs fails to satisfy (e.g., exceeds) a threshold. For instance, one or more product items of the product items are associated with lower RSSIs than the average RSSIs of the other ones of the product items. Accordingly, the product facing application may initiate facing for the one or more product items. Generally, the RSSI variation can be a standard deviation, a variance, or any suitable statistical measure of a variation in a set of data.

In embodiments, the product facing application may have the knowledge that typically two product items (of a particular product) are needed or purchased each hour, and the next scheduled facing process is not for another three hours. Therefore, in this example, the product facing application may need to locate six items. If the product facing application cannot locate six items, the product facing application may determine that the entropy is too high and a facing process is to be initiated. To that end, the product facing application may analyze the tag data to determine a quantity of the product items available (e.g., on a shelf in the store). The product facing application may predict a low-stock event associated with the particular product based on a comparison of the quantity of the product items of the particular product available to sales activity data associated with the particular product. In an example, the product facing application may determine that the quantity of the product items of the particular product available is lower than a predicted quantity of the product items needed (for purchase). Accordingly, the product facing application may initiate facing (e.g., restocking) for the particular product based on the predicted low-stock event.

In embodiments, if the product facing application is not confident about certain readings (i.e., not confident that the product is located within a certain distance (e.g., +/- 2 feet) of the designated point on the front of the shelf) based on the entropy algorithm, the product facing application sends an instruction to an associate to go to a particular location for facing products. In one example, the particular location may be where the majority of the clustering is. In another example, the particular location may correspond to the location indicated by the last one or more confident readings. In yet another example, the particular location may correspond to the location of the product item on the planogram. In embodiments, before sending the instruction, the product facing application may initiate a camera (e.g., a fixed camera at a location nearby the products) to take a picture (an image) of that location, confirm the need for facing (visual confirmation) based on the received picture, and send the picture along with the instruction. For instance, the product facing application may process the image (e.g., using image processing algorithms, machine learning processing, classifications, etc.) to determine whether facing is to be performed.

In embodiments, the system may prioritize facing activities based on the cost and/or the margin of the product items. For instance, the system may initiate facing for a $50 item before a $1 item. In embodiments, the system may prioritize facing activities based on the locations of the product items within the store. For instance, the system may initiate facing for a product item located at a more prominent location (e.g., at the front of the store) before another product item located at a less prominent location (e.g., towards the back of the store). In embodiments, the system may prioritize facing activities based on demands. For instance, the system may initiate facing for a product item of a higher demand than another product item of a lower demand.

In some embodiments, the RFID tag readers may include fixed readers installed at fixed locations within the store. In some embodiments, the RFID tag readers may include portable readers (e.g., handheld devices), for example, located on a cart (e.g., a shopping cart) or in the possession of a store associate and may be moving within the store. In some examples, upon the product facing application identifying a facing opportunity, the product facing application may communicate with a portable reader in the possession of a certain store associate responsible for performing facing (e.g., the store associate may be walking to the shelving unit where the product item for facing is located). In such examples, the portable reader may generate an alert (e.g., an audio or visual alert) when the portable reader detects the product item for facing is in a vicinity of the store associate (e.g., when the store associate approaches the product item for facing).

Scanning and reading tags attached to product items on shelving units continuously to determine facing activities or opportunities can enable real-time targeted facing that would otherwise be unachievable using human efforts. Having location information of the product items and/or RSSIs associated with the tags based on tag data read from the tags can allow for detection of various entropy measures (e.g., deviation from a target a planogram, variations in RSSIs, and/or scatterness of the product items). Using different entropy measures to determine facing activities can enable facing to be initiated based on different perspectives, thereby increasing the flexibility for facing initiations. Using different entropy measures can also result in more accuracy in facing activities.

Providing additional information associated with the location of the product items where facing is to take place can assist an associate in finding that location quickly and efficiently, thereby saving time and resources. Using images of locations of product items to confirm facing activities determined from tag data can improve the accuracy of facing activities instead of triggering a false alert for facing, wasting time and resources for facing. Counting the number of available product items based on the tag data and tracking the availability against sales activity data can enable prediction of a low-stock event and restocking based on the prediction. Prioritizing facing based on costs, margins, demands, and/or locations of product items can increase the effectiveness of facing activities. Generally, real-time targeted facing can improve the efficiency and effectiveness of facing activities and/or meeting customer demands and expectations, thereby increasing revenue generation and customer satisfaction.

While the present disclosure is discussed in the context of facing in a retail store, the disclosed facing mechanisms can additionally or alternatively be used in a manufacturing environment, a warehouse, or any suitable environment where facing of items is of importance. Further, while the present disclosure is discussed in the context of attaching RFID tags to the front of product items, in some instances, RFID tags may be attached to (or part of) price tags of respective product items. In such instances, the entropy measurement mechanisms for identifying facing opportunities and facing prioritizing mechanisms discussed herein may be applied. In a further example, when the price tags are attached with RFID tags, the entropy measurement may also be based on a distance between the price tags and respective product items. That is, if the distance between a product item and its corresponding price tag is greater than a certain threshold (e.g., when the price tag falls off from the product item) or a price tag is missing or not present for a certain product item, an action is to be initiated to re-attach (or attach) the price tag to the product item. Further, while the present disclosure is discussed in the context of initiating an action to notify a store associate to manually perform facing upon detecting a facing opportunity or facing event, in some instances, the product facing process can be automated by using a robotic system (e.g., an automated stocking robot) built with cameras, computer vision (e.g., artificial intelligence (AI) driven), and mechanical mechanisms for performing product facing. In such instances, the product facing application can communicate with the robotic system directly (e.g., via wireless communication links) to initiate a facing processing. In other examples, the computer system that executes the product facing application may be part of the robotic system, and the product facing application may directly initiate and/or control the mechanical mechanisms at the robotic system to perform facing.

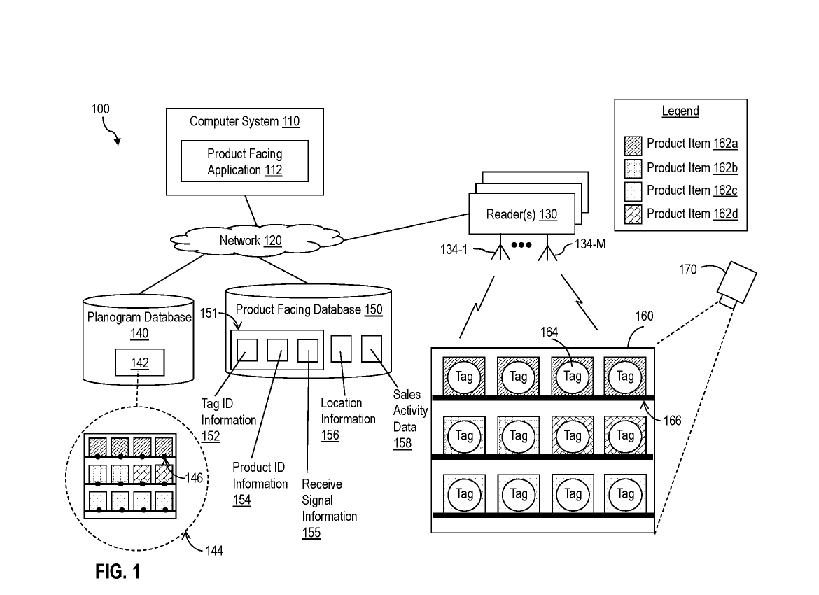

Turning now to FIG. 1, an example facing system 100 that utilizes radio frequency identification (RFID) technologies to provide real-time targeted facing is described. In an example, the system 100 may be part of a retail store. In another example, the system 100 may be part of a manufacturing environment. In yet another example, the system 100 may be part of a warehouse. Generally, the system 100 may be in any suitable environment where facing activities are to be performed. The system 100 may include a computer system 110 (e.g., a server), a network 120, a plurality of readers 130, a planogram database 140, a product facing database 150, a fixed camera 170, and a plurality of tags 164, each attached to a plurality of product items 162 (individually shown as 162a, 162b, 162c, and 162d) on shelves 166 of a shelving unit 160. For ease of illustration, FIG. 1 illustrates twelve tags 164 and corresponding twelve product items 162 on one shelving unit 160. However, the system 100 can include any suitable number of tags 164 and any suitable number of product items 162 on any suitable number of shelving units 160. Further, only one shelf is marked with the label 166. The network 120 promotes communication between the computer system 110, the readers 130, the planogram database 140, the product facing database 150, and the fixed camera 170. The network 120 may be any communication network including a public data network (PDN), a public switched telephone network (PSTN), a private network, and/or a combination.

The readers 130 are wireless communication devices for communicating with the tags 164 and reading data stored at the tags 164. In some instances, the readers 130 may be fixed readers that are installed at fixed locations. In other instances, the readers 130 may be portable readers (e.g., handheld devices). In some examples, a portable reader 130 may be located on a cart (e.g., a shopping cart) or in the possession of a store associate and may be moving within a retail space. Each reader 130 may include baseband circuitry, RF circuitry coupled to the baseband circuitry, one or more antennas 134 coupled to the RF circuitry. The baseband circuitry may perform functions for communicating with the tags 164. The RF circuitry may convert baseband signals to RF signals that can be transmitted by an antenna 134. The RF circuitry may also convert RF signals received from an antenna 134 to baseband signals. The RF signals are shown by the lightning bolts. The antennas 134 are individually shown as 134-1 to 134-M, where M may be any suitable integer value. Generally, each reader 130 may be coupled to 1 to 32 antennas 134. The reader 130 may perform functions for requesting information (e.g., tag identification information and product identification information) from the tags 164 and receiving the information from the tags 164. As will be discussed more fully below, the readers 130 may also communicate with a product facing application 112 at the computer system 110 to facilitate real-time targeted facing activities.

Each tag 164 may include an antenna for transmitting and receiving RF signals and an RFID chip (or integrated circuit (IC)) which stores the respective tag 164’s ID information (e.g., a tag identifier) and other information (e.g., product identification information). As will be discussed more fully below, each tag 164 may be attached to (or embedded in) a product item 162 to facilitate real-time targeted facing. In some instances, a tag 164 may be an active tag including an internal power source, such as a battery. In other instances, a tag 164 may be a passive tag that does not have an internal power source, but instead is remotely powered by a reader 130. For instance, a passive tag 164 may draw power from the RF signal emitted by a reader 130. To that end, the RF signal from the reader 130 may induce a current in one or more coils within the passive tag 164, and the current may be used to power the passive tag 164. A reader 130 may access the information stored on a tag 164 by generating a modulated RF interrogation signal to evoke a modulated RF response from the tag 164. The RF response from the tag 164 may include the coded information stored in the tag 164. The reader 130 may decode the coded information to identify the entity associated with the tag 164.

In the illustrated example of FIG. 1, the product items 162 are of different products. For instance, the product items 162a are of a first product (e.g., cans of beans), the product items 162b are of a second product (e.g., cans of tomato sauce), the product items 162c are of a third product (e.g., cans of corn of a particular brand), and the product items 162d are of a fourth product (e.g., cans of corn of another brand). Generally, different products may refer to products of different types and/or different brands. As discussed above, each product item 162 is attached with a corresponding tag 164. The tag 164 may typically be attached to the front of a product item 162 (e.g., where the pricing label is located). Each tag 164 may store tag identification information (e.g., a tag identifier) identifying the respective tag 164 and product identification information (e.g., a product code) identifying the corresponding product item 162 where the tag 164 is attached. The product identification information can include a SKU code and/or a UPC identifying the product item. A SKU code is an alphanumeric code that a retailer or a manufacturer assigns to each individual product to keep track of inventory internally. On the other hand, UPC codes are universal and can be used to identify a product no matter who is selling it later on, making it useful for external use.

The product facing database 150 may store various data that may facilitate facing activities. For instance, the product facing database 150 may include tag identification information 152, product identification information 154, receive signal information 155, location information 156, and sales activity data 158 associated with respective ones of the plurality of product items 162. For instance, the reader(s) 130 may read data from each individual tag 164, where the read data may include tag identification information 152 (e.g., a tag identifier) identifying the respective tag 164 and product identification information 154 (e.g., a SKU code or a UPC) identifying the corresponding product item 162. The reader(s) 130 may also determine receive signal information 155 (e.g., RSSI measurements) associated with each tag 164 based on a signal reception (e.g., the received signal carrying the tag identification information 152 and the product identification information 154) from the respective tag 164. As will be discussed more fully below, the reader(s) 130 may provide the tag identification information 152, the product identification information 154, and the receive signal information 155 as part of tag data 151 to the product facing application 112. Further, the product facing application 112 may compute location information 156 of the tags 164 and corresponding product items 162 from the RSSIs measurements (e.g., using a triangulation technique). The product facing application 112 may store the received tag data 151 and the computed location information 156 in the product facing database 150. The sales activity data 158 may indicate a quantity of product items 162 that are sold over time (e.g., a given time period). As an example, the sales activity data 158 may indicate that seven product items 162a are sold each hour, three product items 162b are sold each hour, and so on. Generally, the sales activity data 158 may track the number of particular product items 162 sold in any suitable timing granularities.

In some examples, the product facing database 150 may store associations among the tag identification information 152, the product identification information 154, the location information 156, and the sales activity data 158. For instance, the product facing database 150 may store the tag identification information 152 identifying a particular tag 164 in association with the product identification information 154 identifying a product item 162 where the particular tag 164 is attached, the location information 156 of the particular tag 164, and the sales activity data 158 of the respective product item 162.

The planogram database 140 may store planograms 142. A planogram 142 may provide a visual representation that maps out the exact placement of product items 162 on the shelving unit 160, detailing where each product item 162 is to be positioned. An expanded view 144 of a planogram 142 for the product items 162 is shown. In an example, the planogram 142 includes, for each product item 162, a designated point 146 on the front of a respective shelf 166 where the pricing label of the product item 162 is expected to be facing and within a certain distance (e.g., about +/- 2 feet) from this designated point 146 (e.g., shown by the solid circles). For ease of illustration, FIG. 1 illustrates the label for only one designated point 146.

The computer system 110 may include processor(s), non-transitory memory, and a product facing application 112 including instructions stored at the non-transitory memory and executable by the processor(s). According to an embodiment of the present disclosure, the product facing application 112 may receive, from the readers 130, tag data 151 associated with the tags 164. The tag data 151 may include various information, such as tag identification information 152 identifying respective tags, product identification information 154 identifying respective products, and receive signal information 155 (e.g., RSSI measurements) associated with the tags 164. The product facing application 112 may analyze the tag data 151 to determine location information 156 of the tags 164 and corresponding facings of the product items 162.

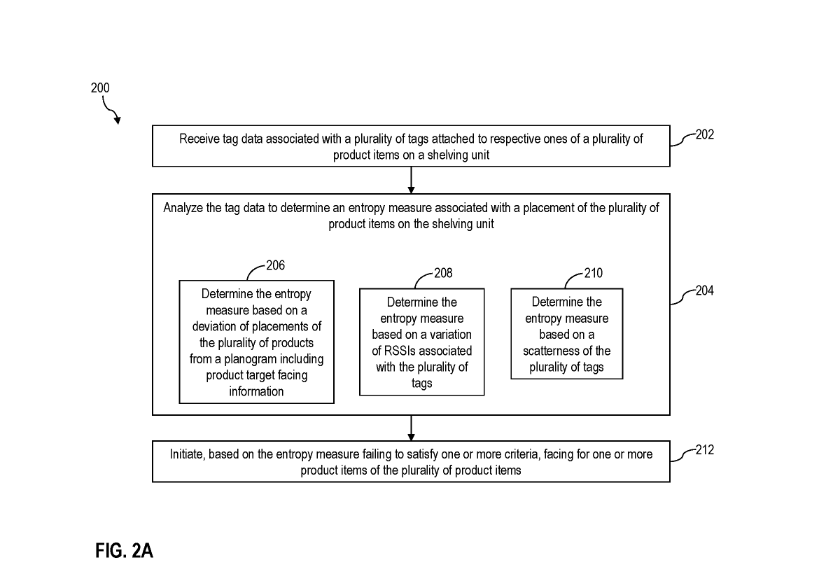

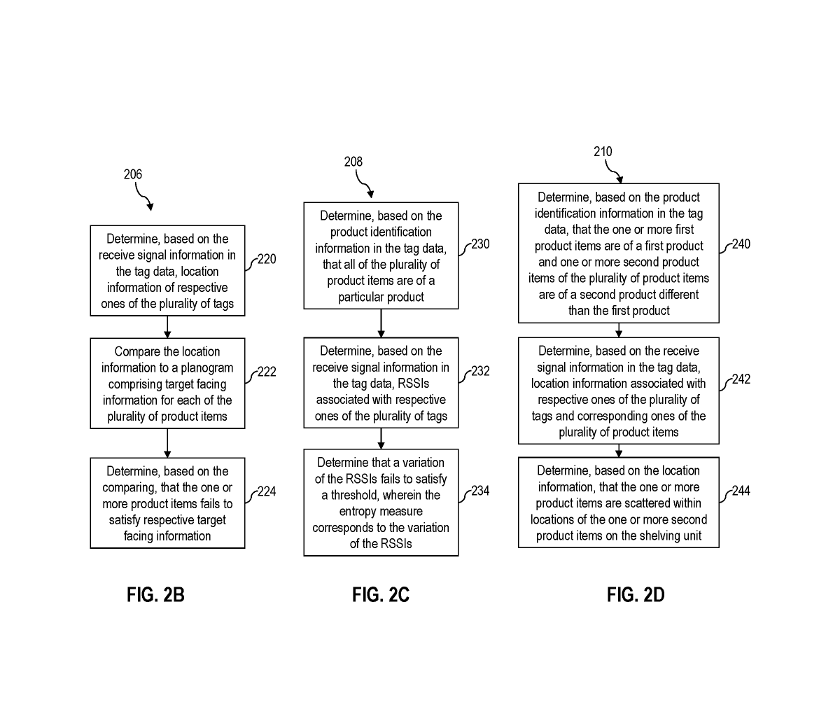

If there isn’t confidence (e.g., a high entropy measure resulting from applying an entropy algorithm to the tag data 151) in the location measurements of the product items 162, the product facing application 112 may infer that facing needs to take place. The product facing application 112 determines clusters of product items 162 based on this tag data 151 and applies an entropy algorithm to suggest a level of disorder or entropy. If the level of disorder or entropy is too high (e.g., exceeds a threshold or fails to satisfy certain criteria), the product facing application 112 may determine that facing should occur, and thus may initiate a facing process. In embodiments, the entropy algorithm may measure a deviation of placements (e.g., positions and/or facings) of the product items 162 from a corresponding planogram 142. In embodiments, the entropy algorithm may measure a scatterness (or randomness) of locations of the cluster of tags 164. In embodiments, the entropy algorithm may measure a variation in RSSI measurements associated with the cluster of tags 164. In some embodiments, the product facing application 112 may further confirm an uncertainty of a facing of a product item 162 based on an image captured by the fixed camera 170. The initiation of facing activities based on an entropy measure of the tags 164 will be discussed more fully below with reference to FIGS. 2A-2C.

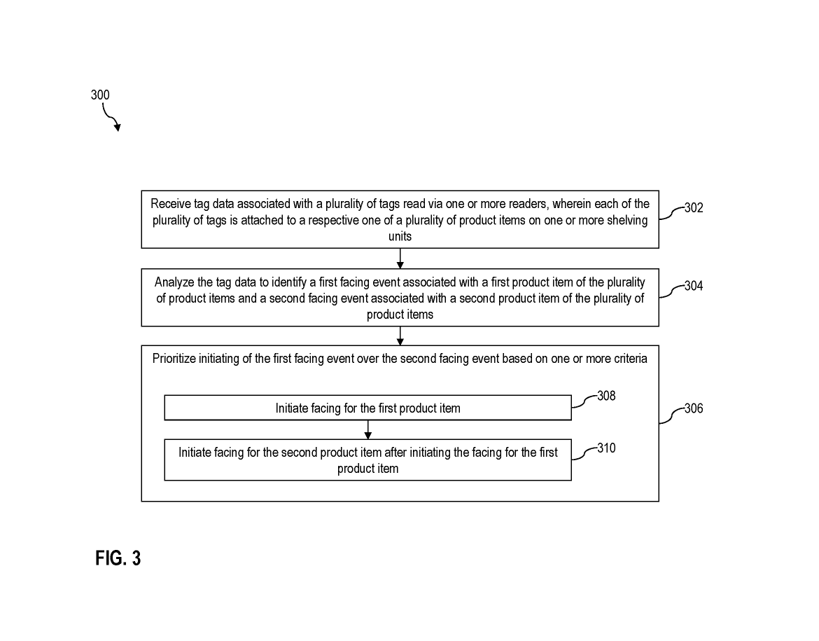

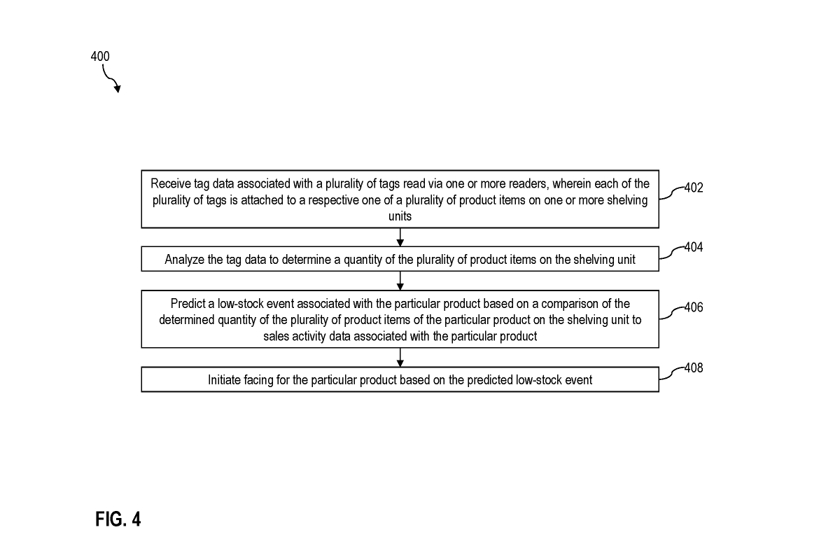

In embodiments, the product facing application 112 may prioritize facing activities based on the costs and/or margins of the respective product items 162, the demand of the respective product items 162, and/or locations of the product items 162 as will be discussed more fully below with reference to FIG. 3. In embodiments, the product facing application 112 may predict a low-stock event based on the sales activity data 158 and initiate facing activities based on the predicted low-stock event as will be discussed more fully below with reference to FIG. 4.

In embodiments, the reader(s) 130 may continuously scan and read the tags 164 and continuously provide tag data 151 to the product facing application 112. The product facing application 112 may continuously analyze the received tag data 151 to determine real-time targeted facing activities or opportunities. The product facing application 112 may store the received tag data 151 and the computed location information 156 in the product facing database 150. In some instances, the product facing application 112 may utilize a combination of information (e.g., the association between the tag identification information 152 and the product identification information 154, the receive signal information 155, and/or the location information 156) stored in the product facing database 150 and currently received tag data 151 to determine facing activities. In some instances, at least some of the information (e.g., the receive signal information 155 and/or the location information 156) in the product facing database 150 may be timestamped, and the product facing application 112 may determine whether the information in the product facing database 150 is valid for use or not based on a comparison of a current time and respective timestamps.

FIG. 1 is merely an example of components of a facing system 100, and variations are contemplated to be within the scope of the present disclosure. In embodiments, the facing system 100 may include other components not illustrated in FIG. 1. In embodiments, the facing system 100 may not include every component illustrated in FIG. 1. In embodiments, the components and connections may be implemented with different connections than those illustrated in FIG. 1. For instance, the tag identification information 152, the product identification information 154, the receive signal information 155, the location information 156, and the sales activity data 158 may be stored in different databases. Such and other embodiments are contemplated to be within the scope of the present disclosure.

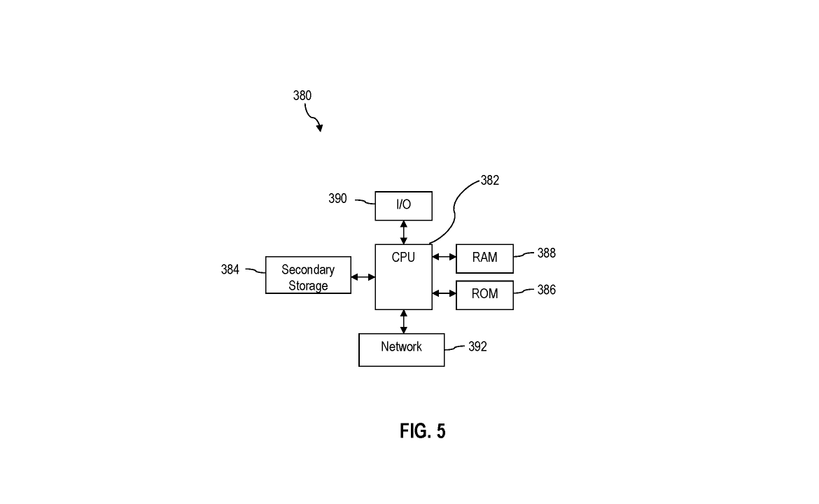

Turning now to FIGS. 2A-2D, a method 200 is described. In an embodiment, the method 200 is a method of providing real-time targeted facing based on an analysis of tag data 151. The method 200 may be implemented by the product facing application 112 in the computer system 110. The method 200 may include similar mechanisms as discussed above with reference to FIG. 1. In embodiments, the method 200 may be implemented using a computer system with components as shown in FIG. 5. As illustrated, FIGS. 2A-2D include a number of enumerated operations, but embodiments of the operations in FIGS. 2A-2D may include additional operations before, after, and in between the enumerated operations. In some embodiments, one or more of the enumerated operations may be omitted or performed in a different order.

Turning now to FIG. 2A, at block 202, the product facing application 112 receives tag data 151 associated with a plurality of tags 164 read via one or more readers 130. Each of the plurality of tags 164 is attached to a respective one of a plurality of product items 162 on a shelving unit 160. The tag data 151 comprises tag identification information 152 and receive signal information 155 associated with respective ones of the plurality of tags 164 and product identification information 154 associated with respective ones of the plurality of product items 162. For instance, the tag identification information 152 may include tag identifiers identifying respective ones of the plurality of tags 164, the product identification information 154 may include product identifiers (e.g., SKU and/or UPC) identifying respective ones of the plurality of product items 162, and the receive signal information 155 may include RSSI measurements associated with respective ones of the plurality of tags 164. In an example, each tag 164 may store a tag identifier identifying the respective tag 164 and a product code (e.g., a SKU code and/or a UPC code) identifying the corresponding product item 162 where the tag 164 is attached. The RSSI measurement associated with each tag 164 may be determined by a corresponding reader 130 based on a signal reception from the respective tag 164.

At block 204, the product facing application 112 analyzes the tag data 151 to determine an entropy measure associated with a placement of the plurality of product items 162 on the shelving unit 160. In an embodiment, as part of analyzing the tag data 151, the product facing application 112 determines the entropy measure based on a deviation of the placement of the plurality of product items 162 from a planogram 142 including product target facing information as shown at block 206 and will be discussed more fully below with reference to FIG. 2B. In an embodiment, as part of analyzing the tag data 151, the product facing application 112 determines the entropy measure based on a variation of RSSIs associated with the plurality of tags 164 as shown at block 208 and will be discussed more fully below with reference to FIG. 2C. In an embodiment, as part of analyzing the tag data 151, the product facing application 112 determines the entropy measure based on a scatterness (e.g., in terms of locations) of the plurality of tags 164 as shown at block 210 and will be discussed more fully below with reference to FIG. 2D.

At block 212, the product facing application 112 initiates, based on the entropy measure failing to satisfy one or more criteria, facing for one or more product items 162 of the plurality of product items 162.

Turning now to FIG. 2B, as part of determining the entropy measure based on the deviation of the placement of the plurality of product items 162 from the planogram 142 at block 206, the product facing application 112 performs operations at block 220-224. For example, at block 220, the product facing application 112 determines, based on the receive signal information 155 in the tag data 151, location information 156 of respective ones of the plurality of tags 164 (e.g., using a triangulation technique). In an example, each tag 164 is attached to the front of a corresponding product item 162, for example, where the pricing label is located. Accordingly, the location information 156 (of the plurality of tags 164) corresponds to facings of respective ones of the plurality of product items 162. At block 222, the product facing application 112 compares the location information 156 to the planogram 142 comprising the target facing information for each of the plurality of product items 162. In some instances, the target facing information comprises a designated point 146 on a front of the shelving unit 160 for an individual product item 162 of the one or more product items 162, and the determining that the one or more product items 162 fails to satisfy the respective target facing information includes determining that a distance between the designated point 146 and a facing of the individual product item 162 fails to satisfy a threshold (e.g., about +/- 2 feet or some other distance), where the facing is based on the location of a corresponding tag 164 that is attached to the individual product item 162. At block 224, the product facing application 112 determines, based on the comparing, that the one or more product items 162 fails to satisfy respective target facing information in the planogram 142.

Turning now to FIG. 2C, as part of determining the entropy measure based on a variation of RSSIs associated with the plurality of tags 164 at block 208, the product facing application 112 performs operations at block 230-234. For example, at block 230, the product facing application 112 determines, based on the product identification information 154 in the tag data 151, that all of the plurality of product items 162 are of a particular product. At block 232, the product facing application 112 determines, based on the receive signal information 155 in the tag data 151, RSSIs associated with respective ones of the plurality of tags 164. At block 234, the product facing application 112 determines that a variation (e.g., a standard deviation, a variance, etc.) of the RSSIs fails to satisfy (e.g., exceeds) a threshold, where the entropy measurement corresponds to the variations of the RSSIs .

Turning now to FIG. 2D, as part of determining the entropy measure based on the scatterness of the plurality of tags 164 at block 210, the product facing application 112 performs operations at block 240-244. At block 240, the product facing application 112 determines, based on the product identification information 154 in the tag data 151, that the one or more product items 162 are of a first product and one or more second product items 162 of the plurality of product items 162 are of a second product different than the first product. At block 242, the product facing application 112 determines, based on the receive signal information 155 in the tag data 151, location information 156 associated with respective ones of the plurality of tags 164 and corresponding ones of the plurality of product items 162. At block 244, the product facing application 112 determines, based on the location information 156, that the one or more product items 162 are scattered within locations of the one or more second product items 162 on the shelving unit 160.

Turning now back to FIG. 2A, in an embodiment, as part of initiating the facing for the one or more product items 162 at block 212, the product facing application 112 transmits an instruction for facing the one or more product items 162, where the instruction includes an indication of location information 156 associated with one or more of the plurality of tags 164 corresponding to the one or more product items 162, where the location information 156 are computed based on the tag data 151 received at block 202. In an embodiment, as part of initiating the facing for the one or more product items 162 at block 212, the product facing application 112 transmits an instruction for facing the one or more product items, where the instruction comprises previous location information 156 associated with the plurality of tags 164. For instance, the product facing application 112 may determine that there is an uncertainty in the location information 156 determined from the tag data 151 received at block 202. Thus, the product facing application 112 may retrieve, from a product facing database 150, the previous (last known and confident) location information 156 and provide the retrieved location information 156 as part of the instruction. In an embodiment, as part of initiating the facing for the one or more product items 162 at block 212, the product facing application 112 transmits an instruction for facing the one or more product items 162, where the instruction includes a planogram 142 including product target facing information for at least the one or more product items 162. In an embodiment, as part of initiating the facing for the one or more product items 162 at block 212, the product facing application 112 transmits an instruction for facing the one or more product items, where the instruction includes an image of a location of one or more of the plurality of tags 164 corresponding to the one or more product items 162. For instance, the product facing application 112 may initiate (or request) a fixed camera 170 located near the shelving unit 160 to capture the image of the product items 162 on the shelving unit 160. The instruction for facing may be electronically transmitted to a store associate for a manual facing action performed by the store associate or electronically transmitted to a robotic system (e.g., an automated stocking robot) for an automated product facing action performed by the robotic system.

In embodiments, the product facing application 112 further receives an image of a location of the plurality of tags 164 and corresponding product items 162 (e.g., captured by the fixed camera 170), and the initiating the facing for the one or more product items at block 212 is further based on a confirmation for the facing of the one or more product items 162 from the image. For instance, the product facing application 112 may process the image (e.g., using image processing algorithms, machine learning processing, classifications, etc.) to determine whether facing is to be performed. The processing of the image may indicate that facing is to be performed for the one or more product items 162. Thus, the product facing application 112 can confirm that facing for the one or more product items 162 is needed based on the image before initiating the facing for the one or more product items 162.

Turning now to FIG. 3, a method 300 is described. In an embodiment, the method 300 is a method of providing real-time targeted facing. The method 300 may be implemented by the product facing application 112 in the computer system 110. The method 300 may include similar mechanisms as discussed above with reference to FIGS. 1 and 2A-2D. In embodiments, the method 300 may be implemented using a computer system with components as shown in FIG. 5. As illustrated, FIG. 3 includes a number of enumerated operations, but embodiments of the operations in FIG. 3 may include additional operations before, after, and in between the enumerated operations. In some embodiments, one or more of the enumerated operations may be omitted or performed in a different order.

At block 302, the product facing application 112 receives tag data 151 associated with a plurality of tags 164 read via one or more readers 130. Each of the plurality of tags 164 is attached to a respective one of a plurality of product items 162 on one or more shelving units 160. At block 304, the product facing application 112 analyzes the tag data 151 to identify a first facing event associated with a first product item 162 of the plurality of product items 162 and a second facing event associated with a second product item 162 of the plurality of product items 162.

At block 306, the product facing application 112 prioritizes the first facing event over the second facing event based on one or more criteria. In an embodiment, the prioritizing the first facing event over the second facing event is based on the first product item 162 being associated with at least one of a higher cost or a higher margin than the second product item 162. In an embodiment, the prioritizing the first facing event over the second facing event is based on the first product item 162 being associated with a higher demand than the second product item 162. In an embodiment, the prioritizing the first facing event over the second facing event is based on the first product item 162 being at a more prominent location than the second product item 162. For instance, the first product item 162 may be located near the front of a store while the second product item 162 may be located towards the back of the store. As part of the prioritizing, the product facing application 112 performs operations at blocks 308 and 310. At block 308, the product facing application 112 initiates facing for the first product item 162. In some instances, as part of the initiating, the product facing application 112 may transmit a first instruction including a first facing planogram for the first product item. At block 310, the product facing application 112 initiates facing for the second product item 162 after initiating the facing for the first product item based on the prioritizing. In some instances, as part of the initiating, the product facing application 112 may transmit a second instruction including a second facing planogram for the second product item. In some instances, the first facing planogram may correspond to the second facing planogram (e.g., a target planogram including facing information for the first product item and the second product item). In other instances, the first facing planogram may be different than the second facing planogram.

Turning now to FIG. 4, a method 400 is described. In an embodiment, the method 400 is a method of providing real-time targeted facing. The method 400 may be implemented by the product facing application 112 in the computer system 110. The method 400 may include similar mechanisms as discussed above with reference to FIGS. 1, 2A-2D, and 3. In embodiments, the method 400 may be implemented using a computer system with components as shown in FIG. 5. As illustrated, FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At block 402, the product facing application 112 receives tag data 151 associated with a plurality of tags 164 read via one or more readers 130, where each of the plurality of tags 164 is attached to a respective one of a plurality of product items 162 of a particular product on a shelving unit 160. In embodiments, the tag data 151 includes first tag data 151 associated with a first tag 164 of the plurality of tags 164 attached to a first product item 162 of the plurality of product items 162, and the first tag data 151 includes tag identification information 152 identifying the first tag 164 and product identification information 154 identifying the first product item 162 being of the particular product.

At block 404, the product facing application 112 analyzes the tag data 151 to determine a quantity of the plurality of product items 162 on the shelving unit 160. For instance, as part of the analyzing, the product facing application 112 may count a number of the plurality of product items 162 having a product identification code (e.g., a SKU code and/or a UPC) of the particular product based on product identification information 154 in the tag data 151.

At block 406, the product facing application 112 predicts a low-stock event associated with the particular product based on a comparison of the determined quantity of the plurality of product items 162 of the particular product on the shelving unit 160 to sales activity data 158 associated with the particular product. In embodiments, the sales activity data 158 indicates a quantity of product items 162 of the particular product sold over a time period (e.g., per hour). At block 408, the product facing application 112 initiates facing for the particular product based on the predicted low-stock event. In embodiments, as part of initiating the facing for the particular product, the product facing application 112 transmits an instruction including a target facing planogram 142 for the particular product.

In embodiments, the product facing application 112 may perform any suitable combination of the methods 200, 300, and 400 discussed above with reference to FIGS. 2A-2D, 3, and 4, respectively.

FIG. 5 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code-division multiple access (CDMA), global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method of analyzing radio frequency identification (RFID) tag data read from RFID tags on product items to provide targeted product facing, the method comprising:
receiving, by an application at a computer system, tag data associated with a plurality of tags read via one or more readers, wherein each of the plurality of tags is attached to a respective one of a plurality of product items on a shelving unit, and wherein the tag data comprises:
tag identification information and receive signal information associated with respective ones of the plurality of tags; and
product identification information associated with respective ones of the plurality of product items;
analyzing, by the application, the tag data to determine an entropy measure associated with a placement of the plurality of product items on the shelving unit; and
initiating, by the application, based on the entropy measure failing to satisfy one or more criteria, facing for one or more product items of the plurality of product items.

2. The method of claim 1, wherein the analyzing comprises:
determining, based on the receive signal information in the tag data, location information of respective ones of the plurality of tags, wherein the location information corresponds to facings of respective ones of the plurality of product items;
comparing the location information to a planogram comprising target facing information for each of the plurality of product items; and
determining, based on the comparing, that the one or more product items fail to satisfy respective target facing information, wherein the entropy measure corresponds to a target facing deviation from the planogram.

3. The method of claim 2, wherein:
the target facing information comprises a designated point on a front of the shelving unit for an individual product item of the one or more product items, and
the determining that the one or more product items fails to satisfy the respective target facing information comprises:
determining that a distance between the designated point and a facing of the individual product item fails to satisfy a threshold.

4. The method of claim 1, wherein the analyzing comprises:
determining, based on the product identification information in the tag data, that all of the plurality of product items are of a particular product;
determining, based on the receive signal information in the tag data, receive signal strength indicators (RSSIs) associated with respective ones of the plurality of tags; and
determining that a variation of the RSSIs fails to satisfy a threshold, wherein the entropy measure corresponds to the variation of the RSSIs.

5. The method of claim 1, wherein the analyzing comprises:
determining, based on the product identification information in the tag data, that the one or more product items are of a first product and one or more second product items of the plurality of product items are of a second product different than the first product;
determining, based on the receive signal information in the tag data, location information associated with respective ones of the plurality of tags and corresponding ones of the plurality of product items; and
determining, based on the location information, that the one or more product items are scattered within locations of the one or more second product items on the shelving unit, wherein the entropy measure corresponds to a scatterness of the plurality of product items.

6. The method of claim 1, wherein the initiating the facing for the one or more product items comprises:
transmitting an instruction for facing the one or more product items, wherein the instruction comprises location information associated with one or more of the plurality of tags corresponding to the one or more product items based on the tag data.

7. The method of claim 1, wherein the initiating the facing for the one or more product items comprises:
retrieving, from a database, based on an uncertainty in location information associated with one or more of the plurality of tags corresponding to the one or more product items determined from the tag data, previous location information associated with the one or more of the plurality of tags; and
transmitting an instruction for facing the one or more product items, wherein the instruction comprises the retrieved previous location information.

8. The method of claim 1, wherein the initiating the facing for the one or more product items comprises:
transmitting an instruction for facing the one or more product items, wherein the instruction comprises a planogram comprising product target facing information for at least the one or more product items.

9. The method of claim 1, wherein the initiating the facing for the one or more product items comprises:
transmitting an instruction for facing the one or more product items, wherein the instruction comprises an image of a location of one or more of the plurality of tags corresponding to the one or more product items.

10. The method of claim 1, further comprising:
receiving, by the application, an image of a location of the plurality of tags and corresponding product items,
wherein the initiating the facing for the one or more product items is further based on a confirmation for the facing of the one or more product items from the image.

11. A computer-implemented method, the method comprising:
receiving, by an application at a computer system, tag data associated with a plurality of tags read via one or more readers, wherein each of the plurality of tags is attached to a respective one of a plurality of product items on one or more shelving units;
analyzing, by the application, the tag data to identify a first facing event associated with a first product item of the plurality of product items and a second facing event associated with a second product item of the plurality of product items; and
prioritizing, by the application, initiation of the first facing event over the second facing event based on one or more criteria, wherein the prioritizing comprises:
initiating, by the application, facing for the first product item; and
initiating, by the application, facing for the second product item after initiating the facing for the first product item.

12. The method of claim 11, wherein the prioritizing the first facing event over the second facing event is based on the first product item being associated with at least one of a higher cost or a higher margin than the second product item.

13. The method of claim 11, wherein the prioritizing the first facing event over the second facing event is based on the first product item being associated with a higher demand than the second product item.

14. The method of claim 11, wherein the prioritizing the first facing event over the second facing event is based on the first product item being at a more prominent location than the second product item.

15. The method of claim 11, wherein
the initiating the facing for the first product item comprises:
transmitting a first instruction comprising a first facing planogram for the first product item, and
the initiating the facing for the second product item comprises:
transmitting a second instruction comprising a second facing planogram for the second product item.

16. A method comprising:
receiving, by an application at a computer system, tag data associated with a plurality of tags read via one or more readers, wherein each of the plurality of tags is attached to a respective one of a plurality of product items of a particular product on a shelving unit;
analyzing, by the application, the tag data to determine a quantity of the plurality of product items on the shelving unit;
predicting, by the application, a low-stock event associated with the particular product based on a comparison of the determined quantity of the plurality of product items of the particular product on the shelving unit to sales activity data associated with the particular product; and
initiating, by the application, facing for the particular product based on the predicted low-stock event.

17. The method of claim 16, wherein
the tag data comprises first tag data associated with a first tag of the plurality of tags attached to a first product item of the plurality of product items, and
the first tag data comprises:
tag identification information identifying the first tag, and
product identification information identifying the first product item being of the particular product.

18. The method of claim 16, wherein the analyzing comprises:
counting a quantity of the plurality of product items having a product identification code of the particular product based on product identification information in the received tag data.

19. The method of claim 16, wherein the sales activity data indicates a quantity of product items of the particular product sold over a time period.

20. The method of claim 16, wherein the initiating the facing for the particular product comprises:
transmitting an instruction comprising a target facing planogram for the particular product.
